(19) United States
(12) Patent Application Publication
(10) Pub. No.: US 2009/0097954 A1
(43) Pub. Date: Apr. 16, 2009

(54) Sheet Separator and Method

(76) Inventors: Stephen Dunlap, Tomball, TX (US); Steven Griffin, Magnolia, TX (US)

Correspondence Address: KENNETH L. NASH, P.O. BOX 680106, HOUSTON, TX, 77268-0106, US

(21) Appl. No.: 11/872,093

(22) Filed: Oct. 15, 2007

(51) Int. Cl. B65G 1/00; B23P 17/04

(52) U.S. Cl. 414/749.1; 29/592

(57) ABSTRACT

The present invention provides a sheet separator and method for use in separating sheets of material, such as sheets of material that are provided in stacks. The sheet separator is inserted at a desired position within the stack of material. The sheet separator has dimensions selected to avoid damage to the sheets of material at the separation point or gap created by the sheet separator. The sheet separator clearly marks the gap into which a forklift blade is to be inserted, whereby damage to the sheets of material can be avoided, and injuries to forklift operators when attempting to slide heavy sheets of material can be reduced or eliminated.

### BACKGROUND OF THE INVENTION

1. Field of the Invention

The present invention relates generally to handling of material and, in one possible embodiment, provides an efficient method for separating sheets of material whereby they are not damaged when separated for lifting with a forklift or the like.

2. Description of the Prior Art

Sheets of materials, such as construction materials and other materials, are often provided in stacks. For instance, sheets of plywood, OSB board, Hardie board, and the like, may be delivered to lumberyards, stores, and/or construction locations in large heavy stacks. These large heavy stacks are then separated as needed and typically moved using forklifts, and the like. However, inserting the tips of the blades of a forklift into the sheets of construction material or other material may frequently damage one or more of the sheets engaged by the forklift blades. The damaged sheets are then typically discarded as overhead cost of the operation or sold as cull lumber. Over time, the losses become quite large. For instance, a typical single construction material store may lose five hundred dollars a month due to damaged sheets of construction material or other sheets of material damaged during separation. However, damage to sheets of construction material or other material when separating out the material is generally considered to be inevitable.

To separate out the sheets of material, the forklift operator counts the appropriate number of sheets which are needed downwardly from the top of the stack, and marks the stack with something he can see from the forklift, e.g., a pen or the like. He then gets on the forklift and inserts one of the forks into the correct spot to create a gap large enough to put a device that will keep the gap open, e.g., a short 1×4, so he can back out and re-approach the stack with both forks or turn into the stack with the first fork inserted. The driver may be about six plus feet away from the tips of the forks when trying to insert the relatively dull tip of the forks into the stack of sheets. The damage arises when the original gap is created by the forks.

The damage may be of different types. The tip may not engage the exact place where the sheets are to be separated but instead may hit the side of a sheet of plywood, Hardie board, or the like, and crack it open. The forces required to open the stack may be relatively large in comparison with the strength of a particular sheet of material. As an example, each sheet of Hardie board may weigh approximately one hundred pounds. If it is desired to separate the top twenty sheets, then the force applied by the tips of the forklift blades into the stack will require approximately two thousand pounds applied upwardly. Quite often, the tips of the blades will not slide smoothly into the stack at the exact position in between the sheets of construction material. Accordingly, one or more sheets may be cracked, torn, scraped, gouged, and/or otherwise damaged. Inserting a screwdriver into the stack may be used, but due to the forces, damage is likely in the area of the sheet against which the screwdriver is inserted. However, a screwdriver may be used anyway because it provides a marking for the position at which the blades must be inserted and, as noted above, damage to sheets during separation is generally considered inevitable.

Injuries may sometimes occur when the forklift operator tries to slide the sheets of materials, which may be quite heavy, off the stack by him or herself. For example, back injuries might occur when the feet are planted and our torso area is twisting to slide the sheet off the stack onto the forks of the forklift. If injuries occur, then the resulting cost of these injuries is tens of thousands of dollars of medical bills in addition the lost time at work.

Consequently, there remains a need to provide an improved sheet separator and method. Those of skill in the art will appreciate the present invention, which addresses the above problems and other significant problems uncovered by the inventor that are discussed hereinafter.

### SUMMARY OF THE INVENTION

Accordingly, it is an objective of the present invention to provide an improved sheet separator and method.

Another possible objective is to save time when separating sheets of construction material or other material.

Yet another possible objective is to reduce injuries when forklift operators handle sheets of materials, which may be quite heavy.

Another possible objective is reducing damage caused by the normal operation of a forklift when separating sheets of construction material.

Yet another possible objective is a low cost, easily operated device to separate sheets of material.

These and other objectives, features, and advantages of the present invention will become apparent from the drawings, the descriptions given herein, and the appended claims. However, it will be understood that above-listed objectives and/or advantages of the invention are intended only as an aid in understanding aspects of the invention. are not intended to limit the invention in any way, and therefore do not form a comprehensive or restrictive list of objectives, and/or features, and/or advantages. Moreover, the scope of this patent is not limited to its literal terms but instead embraces all equivalents to the claims described.

In one possible embodiment, a method is provided for making a sheet separator which may be used by a forklift operator in separating sheets. The method may comprise one or more steps. A non-limiting example might comprise a step of forming an elongate handle which might comprise a length of between three inches and seven inches.

Other steps may comprise mounting an insertion blade transversely to the elongate handle. In one embodiment, the insertion blade might be mounted within one inch from a midway point along the elongate handle.

In one embodiment, the method might further comprise providing that the insertion blade comprises a wedge-shaped profile defined by a height that begins with an insertion edge with an edge thickness of between 0.01 and 0.02 inches, or some other suitable range of values, depending on the sheets of material to be separated.

In a possible embodiment, the insertion blade height may increase gradually and/or continuously with distance from the insertion blade to a height of at least three-eighths inches or more. In one possible embodiment, the blade height might increase continuously for at least two inches along an insertion blade length.

Another possible step may comprise providing that the insertion blade is greater than three-quarter inches in width. In another possible embodiment, the method may comprise forming the elongate handle and the insertion blade with monolithic one-piece construction of synthetic material, plastic, composite material, nylons, metal, aluminum, or any other suitable material. In another possible embodiment, the method may comprise providing a flat portion for the handle on an opposite side of the elongate handle from the insertion blade.

In another embodiment of the invention, a sheet separator may comprise features utilized for separating sheets, some possibilities of which are discussed below. As a nor-limiting example only, an elongate handle might comprise an elongate length of from three to eight inches and/or an insertion blade mounted transversely to the elongate length of the elongate handle. In one embodiment, the insertion blade may comprise a blade width greater than one-half inch and/or an insertion edge sized for insertion between the sheets of construction material or other material and/or a blade height which increases with distance from the insertion edge.

The sheet separator may comprise a blade width for the insertion blade greater than one inch and/or the elongate handle and the insertion blade may be of one-piece construction so as to be monolithic in construction. In one embodiment, the elongate handle and the insertion blade may be comprised of synthetic material, metal, composite materials, or the like. For instance, the sheet separator may comprise plastic, nylon, aluminum, or other suitable materials or combinations of materials. In another embodiment, the blade height may increase with distance from the insertion edge such that the insertion blade comprises a wedge-shaped profile.

In yet another possible embodiment of the invention, a method may comprise forming an elongate handle and an insertion blade mounted transversely to the elongate handle and/or providing that the insertion blade comprises a wedge-shaped profile defined by a height that begins with an insertion edge sized for insertion between the sheets of construction material or other material with an insertion blade height that increases with distance from the insertion blade and/or providing that the insertion blade is greater than three-quarter inches in width and is greater than two inches in length.

The above summary is provided as a convenience only to provide an understanding of possible embodiments of the invention and is not intended to be limited to a particular embodiment of the invention.

### BRIEF DESCRIPTION OF DRAWINGS

For a further understanding of the nature and objects of the present invention, reference should be had to the following detailed description, taken in conjunction with the accompanying drawings, in which like elements may be given the same or analogous reference numbers and wherein:

FIG. 1 is a perspective view, showing a sheet separator in accord with one possible embodiment of the present invention;

FIG. 2 is a perspective view showing a sheet separator inserted into a stack of sheets of construction material or other material in accord with one possible embodiment of the present invention;

FIG. 3 is a perspective view, showing a tip of a forklift being inserted into the stack adjacent a sheet separator in accord with one possible embodiment of the present invention; and

FIG. 4 is a perspective view, showing the tips of a forklift inserted into the stack adjacent a sheet separator in accord with one possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### DETAILED DESCRIPTION OF THE PREFERRED EMBODIMENTS

The present invention provides a low-cost, easy-to-use, device that can save the user time and also greatly reduce, and perhaps largely eliminate, losses caused by the normal operation of the forklift. Thus, for a relatively low cost, a typical construction material store might save about one thousand dollars per month in losses due to damage of sheet material, while actually increasing the speed of delivery of sheet material.

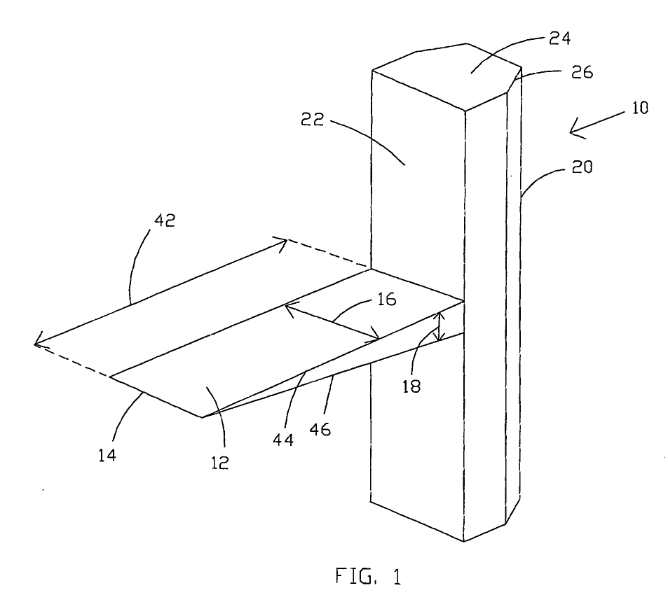

Referring now to the drawings and, more particularly to FIG. 1 there is shown one possible embodiment of sheet separator 10 in accord with the present invention. Sheet separator 10 may be made of any suitable materials such as plastic, synthetic material, nylon, composite material, nylon, metal, aluminum, other materials, combinations of the above or other materials, or the like.

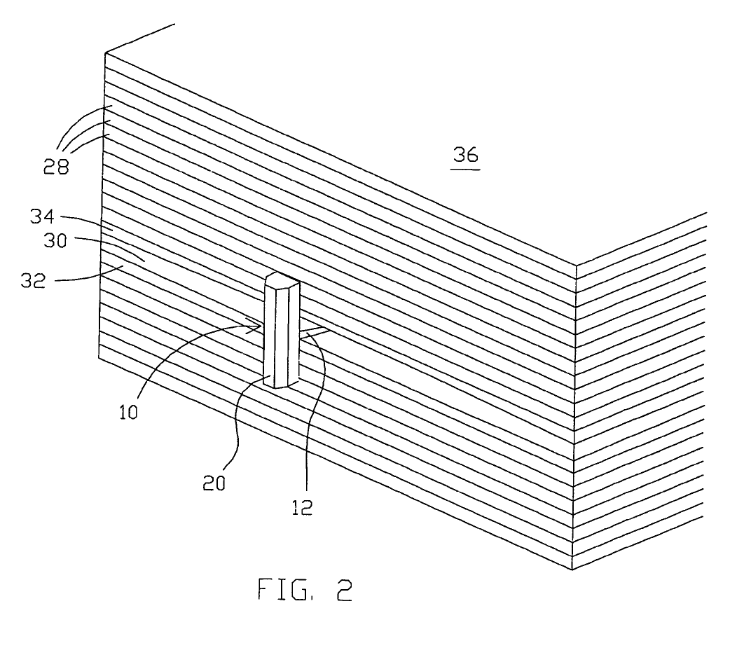

In a preferred embodiment, sheet separator 10 utilizes a relatively wide insertion blade 12 for making an initial insertion into a stack of construction material, such as construction material or other material stack 36 shown in FIG. 2. The width 16 of insertion blade 12 is selected to be wide enough to avoid damage to the sheets of material, which may result from the weight of the stack of material above insertion blade 12 acting on insertion blade 12. This is one reason why the use of a screwdriver when separating sheets of material is likely to damage one or both of the sheets separated.

Thus, for relatively soft construction material, width 16 of insertion blade 12 must be relatively wide. Whereas for harder materials, width 16 of insertion blade 12 could be less wide. Another consideration is the resulting size of sheet separator 10, which may preferably be kept relatively small for convenience, prevention of damage, and ease when handling, inserting, and constructing. Length 42 and height 18 of insertion blade 12 may preferably also be taken into consideration and selection of width 16 of insertion blade 12, as discussed below.

Through trial and error, it has been found that an insertion blade width 16 may be about 1⅛″ to avoid damage of sheets of most types of construction material or other material while remaining small enough to be easily handled and/or constructed. With width 16 being provided at or about this value, sheet separator 10 may be used to separate large numbers of sheets of construction material or other material with a relatively small amount of insertion force.

However, it will be appreciated that insertion blade 12 may be considerably wider and at least somewhat smaller. For instance, yet another possible embodiment, insertion blade 12 may have a range of width from ¾″ to 2 inches. In yet another possible embodiment, another range of width may be ½″ to four inches. Many other possible ranges of values within these ranges of width may also be used. As well, insertion blade 12 may have a width larger than or smaller than these ranges. As one of skill becomes familiar with the use of sheet separator 10, one of skill will then appreciate that as the width of insertion blade 12 increases, that the friction or force required to insert insertion blade 12 into the stack of construction material or other material also increases. Thus, if the width of insertion blade 12 is greater than about a foot or so for most construction materials, insertion may be quite difficult. On the other hand, as the width of insertion blade 12 decreases, the likelihood of damage to softer sheets of construction material or other material increases.

In one possible preferred embodiment, insertion blade 12 may be wedge shaped to provide a relatively sharp blade edge 14 that is easily insertable into a stack of construction material or other material sheets. In one possible embodiment, blade edge 14 may have dimensions from 0.01 to 0.015 inches. It is necessary that blade edge 14 be easily insertable between the sheets of construction material, and that a suitable sharpness of blade edge 14 be selected for this purpose.

The blade height 18 of insertion blade 12 may increase, preferably but not necessarily continuously, with distance from blade edge 14. Upper surface 44 and lower surface 46 may be, but do not have to be, flat surfaces. For instance, upper surface 44 and lower surface 46 may be rounded, elliptical, partially rounded, and/or the like.

Insertion blade length 42 and height 18 are also selected, as discussed above with respect to width 16, for convenience, prevention of damage, and ease when handling, inserting, and constructing. A longer length 42 permits a more gradual creation of a gap between sheets of construction material. Thus, a longer length 42 is less likely to cause damage, especially to softer types of construction material. On the other hand, as length 42 increases, the time it takes for a user to insert sheet separator 10 tends to increase, the overall difficulty of handling sheet separator 10 tends to increase, and costs of manufacturing tend to increase. In one possible preferred embodiment, it has been found that three inches is a useful value of length 42 when the above discussed considerations are taken into account. However, in another possible embodiment, length 42 may also be provided in a range from two inches to four inches. In another possible embodiment, length 42 may be provided in a range from two inches to six inches. In another possible embodiment, length 42 may be provided in a range from one inch to twelve inches. In another possible embodiment, length 42 may be in a range from two inches to six inches.

Moreover, length 42 is not necessarily limited to these ranges and may be adjusted in light of the above considerations. Thus, other suitable ranges of values for length 42 may be found within the above ranges.

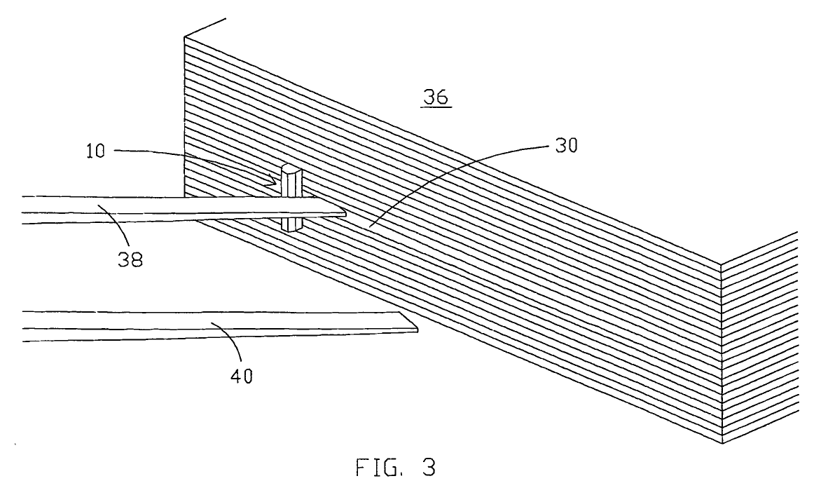

Considerations for selection of height 18 are similar to those for selection of length 42 and width 16. Height 18 should preferably be small enough to easily allow insertion of a forklift blade, such as forklift blade 38 shown in FIG. 3, without damage to the construction material. Height 18 should preferably be large enough so that a forklift operator can easily see the gap created due to height 18, such as gap 30 shown in FIG. 3. In one possible preferred embodiment, height 18 is ½.″ In another possible embodiment, height 18 may be of a value between ¼″ and ¾.″ In another possible embodiment, height 18 may be of a value between ⅛″ and 1 inch. Depending on the type of construction material or other material for intended use, height 18 may be selected to be a suitable value. Height 18 may be within or outside of the above ranges of values, as desired.

One possible embodiment of handle 20 of sheet separator 10 is shown in FIG. 1. In this embodiment, handle 20 may be easily gripped and is of large enough surface area to allow a user to easily apply considerable insertion force without hurting the user's hand. Once inserted, the flat back of handle 20 is suitable for a hammer to apply additional force, if necessary. Handle 20 also has relatively rounded sides to avoid sharp edges and thereby provide additional comfort for the user's hand. In this embodiment, handle edge 26 is angled at about 45° between the back surface and the side surface, as shown by viewing handle top surface 24. In this embodiment, handle 20 provides a hexagonal shape. However, handle 20 may be of various configurations, as desired. In this embodiment, handle 20 and insertion blade 12 are of one-piece construction. The front surface 22 of handle 20 may be flat as shown, but could also be rounded. In one preferred embodiment, the front surface 22 provides a relatively straight engagement surface for engaging the side of a stack of sheets of construction material.

In one embodiment, handle 20 is a vertical length as shown in FIG. 1 of 4 inches, which has been found to be a convenient length for use with some standard types of sheets of construction material. However, in another possible embodiment, the vertical length could vary in a range from 3 inches to 8 inches. In another possible embodiment, the vertical length could vary in a range from 3.5 inches to 6.5 inches. Depending on the use, handle 20 may also have a value of length outside of these ranges. In one preferred embodiment, insertion blade 12 is mounted about midway along the vertical length of handle 20, and extends outwardly and/or transversely and/or perpendicular to handle 20. While in one preferred embodiment, insertion blade 12 is mounted midway along the vertical length of handle 20, insertion blade 12 could also be offset from the middle of handle 20. For instance, in one embodiment, insertion blade 12 may be positioned in a range from 1 inch below the midpoint to 1 inch above the midpoint. If handle 20 were longer than 4 inches, the range in which insertion blade 12 may be mounted could be varied proportionately. However, insertion blade 12 may be mounted outside this range, if desired.

General operation of sheet separator 10 is illustrated in FIG. 2-FIG. 4. Stack 36 contains sheets of material, such as sheets 28, 32, and 34. Sheet separator 10 may be inserted into stack 36 to create gap 30 between sheets 32 and 34. A forklift operator may then insert forklift blade 38 into gap 30, raise forklift blade 38 upwardly, rotate the forklift around to engage forklift blade 40, and then proceed with lifting the desired sheets of construction material or other material in the typical fashion.

In one possible example of operation, the procedure may be as follows:

Step one: The forklift operator gets off the forklift and counts down from the top of stack 30 how many sheets need to be taken off stack 30.

Step two: Once the count of sheets is made, the forklift operator takes sheet separator 10 and inserts the tool beneath the bottom sheet that he or she is going to remove from the stack, for instance, beneath sheet 34. Sheet separator 10, when inserted, may in one embodiment create a gap of up to ½,″ which is large enough for the forklift operator to insert the tips of the forklift, such as the tip of forklift blade 38, into stack 36 of sheets of construction material.

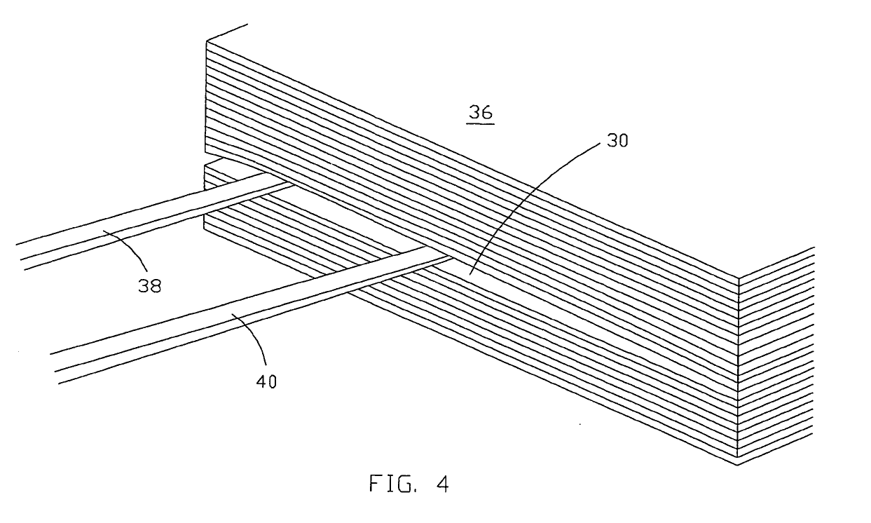

Step three: The forklift operator returns to the forklift and inserts the tips for the forklift into the stack of sheets. As the forks go into the stack, sheet separator 10 will fall out as indicated in FIG. 4 and can be replaced, if necessary, with a block of some type (not shown), such as a piece of 2×4 or the like, to maintain the largest possible gap enabling the forklift operator to fully penetrate the stack without damaging any material.

As another example, which might involve use with Hardie board or other types of construction material, the operator may be removing 14 sheets from the stack of Hardie board, wherein each sheet weighs approximately 100 pounds, totaling approximately 1,400 pounds. Using sheet separator 10 with dimensions as described above, the operator can insert the sheet separator 10, by hand, into stack 36 of Hardie board and create the necessary space, even though the weight of the Hardie board above the tool is approximately 1,400 pounds.

While the above examples show use of a single sheet separator 10, using two or more sheet separator tools may be helpful to the forklift operator, perhaps when dealing with more flexible sheets of material, or wider sheets of material.

Accordingly, the present invention provides a lightweight and simple tool that not only speeds the operations for separating sheets of material, but for many stores may result in a savings of approximately $500 or more per month due to damaged sheets of construction material, which losses in the past have been considered unavoidable as a practical matter. The present invention also reduces the likelihood of injuries that may sometimes occur when the forklift operator tries to slide the sheets of materials, which may be quite heavy, off the stack by him or herself. The present invention essentially eliminates the need to take these types of risks, thereby potentially paying the cost of the tool many times over even if only one injury is avoided.

In general, it will be understood that such terms as “up,” “down,” “vertical,” and the like, are made with reference to the drawings and/or the earth and/or the typical orientation of the components. It will be understood that the devices may not be arranged in such positions at all times depending on variations in operation, transportation, mounting, and the like. As well, the drawings are intended to describe the concepts of the invention so that the presently preferred embodiments of the invention will be plainly disclosed to one of skill in the art, but are not intended to be manufacturing level drawings or renditions of final products and may include simplified conceptual views as desired for easier and quicker understanding or explanation of the invention. The relative size and shape of the components may be greatly different from that shown and the invention still operates in accord with the novel principals taught herein.

Although a particular sheet separator 10 and method have been described, other possible constructions and methods could be used. The foregoing disclosure and description of the invention is therefore illustrative and explanatory of a presently preferred embodiment of the invention and variations thereof, and it will be appreciated by those skilled in the art that various changes in the design, organization, order of operation, means of operation, equipment structures and location, methodology, and use of mechanical equivalents, as well as in the details of the illustrated construction or combinations of features of the various elements, may be made without departing from the spirit of the invention. Moreover, the scope of a patent is not limited to its literal terms but instead embraces all equivalents to the claims described.

Accordingly, because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

What is claimed is:

1. A method for making a sheet separator for use by a forklift operator in separating sheets of material from a stack of sheets by manual insertion between said sheets of material comprising:
forming an elongate handle with a length of between three inches and seven inches;
mounting an insertion blade transversely to said elongate handle within one inch from a midway point along said elongate handle;
providing that said insertion blade comprises a wedge-shaped profile defined by a height that begins with an insertion edge;
providing that said insertion blade height increases continuously with distance from said insertion blade to a height of at least three-eighths inches, said blade height increasing continuously for at least two inches along an insertion blade length; and
providing that said insertion blade is greater than three-quarter inches in width.

2. The method of claim 1, further comprising forming said elongate handle and said insertion blade with monolithic one-piece construction of synthetic material, plastic, composite material, nylon, metal, or aluminum.

3. The method of claim 1, further comprising providing a flat portion for said handle on an opposite side of said elongate handle from said insertion blade.

4. A sheet separator for use by a forklift operator in separating sheets of material from a stack of sheets by manual insertion between said sheets of material, comprising:
an elongate handle with an elongate length of from three to eight inches; and
an insertion blade mounted transversely to said elongate length of said elongate handle, said insertion blade comprising a blade width greater than one-half inch, an insertion edge sized for insertion between said sheets of material, and a blade height which increases with distance from said insertion edge.

5. The sheet separator of claim 4, wherein said blade width of said insertion blade is greater than one inch.

6. The sheet separator of claim 5, wherein said elongate handle and said insertion blade are of one-piece construction so as to be monolithic in construction.

7. The sheet separator of claim 6, wherein said elongate handle and said insertion blade are comprised of plastic.

8. The sheet separator of claim 4, wherein said blade height increases with distance from said insertion edge such that said insertion blade comprises a wedge-shaped profile.

9. The sheet separator of claim 8, wherein said blade height has a maximum height of at least one-half inch.

10. The sheet separator of claim 9, further comprising a blade length that is at least three inches.

11. The sheet separator of claim 4, wherein said elongate handle and said insertion blade are of one-piece construction.

12. A method for making a sheet separator for use by a forklift operator in separating sheets of material from a stack of sheets of material by manual insertion between said sheets of material, comprising:
forming an elongate handle and an insertion blade mounted transversely to said elongate handle;
providing that said insertion blade comprises a wedge-shaped profile defined by a height that begins with an insertion edge sized for insertion between said sheets of material with an insertion blade height that increases with distance from said insertion blade; and
providing that said insertion blade is greater than three-quarter inches in width and is greater than two inches in length.

13. The method of claim 12, further comprising forming said elongate handle and said insertion blade with monolithic one-piece construction.

14. The method of claim 13, further comprising forming said elongate handle and said insertion blade of plastic, synthetic material, nylon, composite material, nylon, or metal.

15. The method of claim 12, further comprising forming said insertion blade height such that said height increases continuously to a height of at least one-half inch.

16. The method of claim 15, further comprising forming said insertion blade with a length of at least three inches.

17. The method of claim 16, further comprising mounting said insertion blade within one inch from a midway point along said elongate handle.

18. The method of claim 17, further comprising providing that said elongate handle has a length of between three inches and seven inches.

19. The method of claim 18, further comprising providing that said insertion edge has an edge thickness of between 0.01 to 0.02 inches.

20. The method of claim 12, further comprising providing that said insertion blade is at least one and one-half inches in width and is greater than two inches in length.
